(19) United States
(12) Patent Application Publication
(10) Pub. No.: US 2013/0291687 A1
(43) Pub. Date: Nov. 7, 2013

(54) Pet Identification Tag Beverage Opener

(71) Applicants: Christopher N. Meyer, Sunnyvale, CA (US); Geoffrey T. Thiel, Sunnyvale, CA (US); Christopher A. Ohms, San Mateo, CA (US)

(72) Inventors: Christopher N. Meyer, Sunnyvale, CA (US); Geoffrey T. Thiel, Sunnyvale, CA (US); Christopher A. Ohms, San Mateo, CA (US)

(21) Appl. No.: 13/461,797

(22) Filed: May 2, 2012

(51) Int. Cl. B67B 7/44

(52) U.S. Cl. 81/3.09

(57) ABSTRACT

Pet identification tag beverage opener systems and methods are herein disclosed. According to one embodiment an exemplary pet identification tag beverage opener includes an attachment means, an identification region, a beverage opener and a lever arm.

### FIELD OF TECHNOLOGY

The present disclosure is directed to systems and methods for providing utility to pet identification devices. More specifically, the present disclosure is directed to pet identification tag beverage opener systems and methods.

### BACKGROUND

Devices for identifying domesticated pets are known in the art. A system including a collar and an identification tag is widely used. The collar wraps around the neck of the domestic pet and typically includes an attachment point, such as a metal ring, for a leash and/or an identification tag.

Systems combining a pet collar and bottle opener art also know in the art. U.S. patent Ser. No. 12/648,240 discloses a combination pet collar and bottle opener that can be worn by a dog.

Improved systems and methods for providing utility to pet identifiers are herein disclosed.

### SUMMARY

The present disclosure is directed to systems and methods for providing utility to pet identification devices. More specifically, the present disclosure is directed to pet identification tag beverage opener systems and methods that overcome the limitations of the prior art and add utility to pet identification tags.

According to one embodiment an exemplary pet identification tag beverage opener includes an attachment means, an identification region, a beverage opener and a lever arm.

The foregoing and other objects, features and advantages of the present disclosure will become more readily apparent from the following detailed description of exemplary embodiments as disclosed herein.

### BRIEF DESCRIPTION OF THE DRAWINGS

Embodiments of the present application are described, by way of example only, with reference to the attached Figures, wherein:

FIG. 1 illustrates a top offset view of an exemplary pet identification tag beverage opener according to one embodiment;

FIG. 2 illustrates a bottom offset view of an exemplary pet identification tag beverage opener according to one embodiment;

FIG. 3 illustrates a top offset view of an exemplary pet identification tag beverage opener according to another embodiment;

FIG. 4 illustrates a top offset view of an exemplary pet identification tag beverage opener according to another embodiment; and

FIG. 5 illustrates an exemplary identification tag beverage opener attached to a pet collar according to one embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, methods, procedures and components have not been described in detail so as not to obscure the embodiments described herein.

The present disclosure is directed to pet identification tag beverage opener systems and methods that overcome the limitations of the prior art and add utility to pet identification tags. The systems and methods herein disclosed can be attached for use on any domestic pet or animal including, but not limited to dogs, cats, hamsters, rabbits, ferrets, horses, weasels, chimpanzees, lions, tiger, bears, reptiles or any other domestic pet or animal.

FIG. 1 illustrates a top offset view of an exemplary pet identification tag beverage opener 1 according to one embodiment. The exemplary pet identification tag beverage opener 1 includes an attachment means 2, an identification region 4, a beverage opener 6, and a lever arm 8.

The pet identification tag beverage opener 1 including the beverage opener 6 and lever arm 8 is made with specific dimensions (height, thickness, length) and material(s) imparting sufficient strength and toughness to open beverages over several cycles throughout the operating life of the pet identification tag beverage opener 1. The pet identification tag beverage opener 1 including the beverage opener 6 and lever arm 8 can be made from any materials or combination of materials including but not limited to one or more of the following materials: metals, alloys, ceramics, plastics, and composites.

The attachment means 2 can be any element upon or within the body or lever arm 8 for attaching the pet identification tag beverage opener 1 to a pet. In an exemplary embodiment, the attachment means 2 is a hole provided within the body or lever arm 8 of the pet identification tag beverage opener 1. A ring, rope, wire, string, split key ring, strap, zip tie, wire, rubber band or other element (not shown) can be used in conjunction with the attachment means hole 2 to attach the pet identification tag beverage opener 1 to a collar, ring, rope, wire or other element (not shown) around a pet's neck.

The identification region 4 has a surface area large enough to contain and display identification information. Identification information can be permanently or temporarily affixed within the identification region 4. Identification information can be permanently applied in any number of ways including, but not limited to engraving, laser engraving, etching, writing, electrical discharge machining or any other method known in the art for affixing information to a specific material. The identification information can include pet information or pet owner information including, but not limited to, pet name, pet age, pet temperament, pet vaccination information, pet veterinarian address, pet owner name, pet owner address, pet owner telephone number or other desired information related to the pet or pet owner. Claims

The beverage opener 6 can be a protruding element fixed to the body of the pet identification tag beverage opener 1 for wedging and/or leveraging a surface of a beverage or bottle cap between the beverage opener 6 and a distal end of the pet identification tag beverage opener 1. The beverage opener 6 can be a protruding flange, L-shaped element or claw for wedging and/or leveraging a surface of a beverage or bottle cap between the beverage opener 6 and a distal end of the pet identification tag beverage opener 1. The beverage opener 6 has specific dimensions (thickness, width, length) providing sufficient strength for prying off a beverage or bottle cap in operation while the pet identification tag beverage opener 1 is attached to the pet. The beverage opener 6 is made with specific dimensions (height, thickness, length) and material(s) imparting sufficient strength and toughness to open beverages over several cycles throughout the life of the pet identification tag beverage opener 1.

The lever arm 8 makes up a portion of the body of the pet identification tag beverage opener 1. The lever arm 8 has specific dimensions (thickness, width, length) providing sufficient leverage for removing a beverage or bottle cap in operation while the pet identification tag beverage opener 1 is attached to the pet. The lever arm 8 is made with specific dimensions (height, thickness, length) and material(s) imparting sufficient strength and toughness to open beverages over several cycles throughout the life of the pet identification tag beverage opener 1.

In operation, the pet identification tag beverage opener 1 can be used to open a sealed beverage by wedging or fixing the beverage opener 6 upon a surface of beverage container or cap and imparting an angular force upon the lever arm 8 sufficient to pry or leverage off the beverage cap. Additionally, the identification region 4 provides identification information to identify the pet, the owner of the pet and the owner of the pet identification tag beverage opener 1 in case the pet or pet identification tag beverage opener 1 is lost.

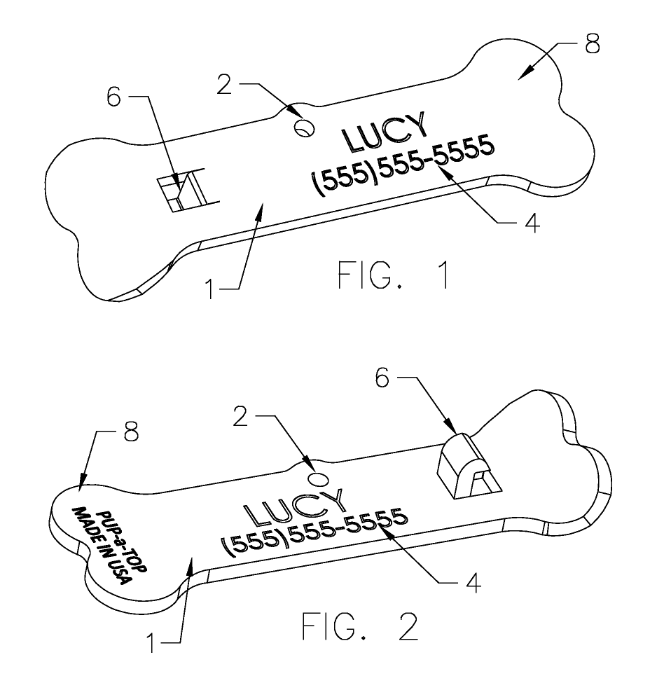

FIG. 2 illustrates a bottom offset view of an exemplary pet identification tag beverage opener according to the embodiment described in FIG. 1. The bottom offset view more clearly illustrates the beverage opener 6 element. The beverage opener 6 can fit around the edge of a conventional crimped bottle cap and act as a fulcrum to allow an operator to pry-off a bottle cap via the lever arm 8.

Although the location of the attachment means 2 is not critical, the attachment means 2 can be located at a geographic center (i.e. with respect to one or more axes) or at or near the center of gravity of the pet identification tag beverage opener 1. The attachment means 2 is centrally located in FIGS. 1 and 2 to provide the most convenient configuration for pivoting the pet identification tag beverage opener 1 around a central point during operation. Centrally locating the attachment means 2 prevents the operator from using a pet's collar and/or a pet's neck for leverage to open a bottle.

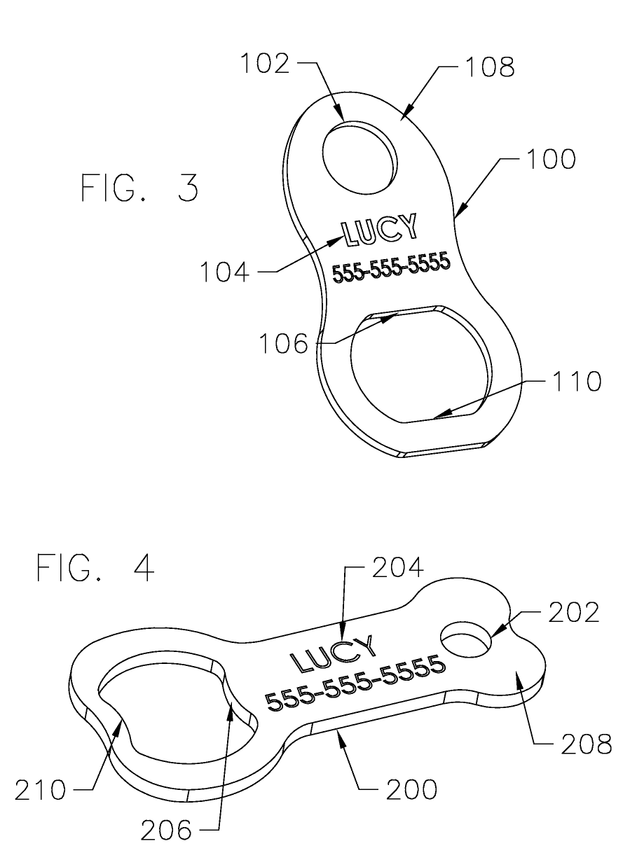

FIG. 3 illustrates a top offset view of an exemplary pet identification tag beverage opener 100 according to another embodiment. The pet identification tag beverage opener 100 includes an attachment means 102, an identification region 104, a beverage opener 106, and a lever arm 108.

The pet identification tag beverage opener 100 including the beverage opener 106 and lever arm 108 is made with specific dimensions (height, thickness, length) and material(s) imparting sufficient strength and toughness to open beverages over several cycles throughout the life of the pet identification tag beverage opener 100. The pet identification tag beverage opener 100 including the beverage opener 106 and lever arm 108 can be made from any materials or combination of materials including, but not limited to one or more of the following materials: metals, alloys, ceramics, plastics, and composites.

The attachment means 102 can be any element upon or within the body or lever arm 108 for attaching the pet identification tag beverage opener 100 to a pet. In an exemplary embodiment, the attachment means 102 is a hole provided within the body or lever arm 108 of the pet identification tag beverage opener 100. A ring, rope, wire, split key ring, string, strap, zip tie, wire, rubber band or other element (not shown) can be used in conjunction with the attachment means hole 102 to attach the pet identification tag beverage opener 100 to a collar, ring, rope, wire or other element (not shown) around a pet's neck.

Although the location of the attachment means 102 is not critical, the attachment means 102 can be located at a geographic center (i.e. with respect to one or more axes) or at or near the center of gravity of the pet identification tag beverage opener 100. The attachment means 102 is centrally located in FIG. 3 to provide the most convenient configuration for pivoting the pet identification tag beverage opener 100 around a central point during operation.

The identification region 104 has a surface area large enough to contain and display identification information. Identification information can be permanently or temporarily affixed within the identification region 104. Identification information can be permanently applied in any number of ways including, but not limited to engraving, laser engraving, etching, writing, electrical discharge machining or any other method known in the art for affixing information to a specific material. The identification information can include pet information or pet owner information including, but not limited to, pet name, pet age, pet temperament, pet vaccination information, pet veterinarian address, pet owner name, pet owner address, pet owner telephone number or other desired information related to the pet or pet owner.

The beverage opener 106 is a pocket or recess portion of the body of the pet identification tag beverage opener 100. The beverage opener recess portion or pocket 106 includes an engaging surface shaped for wedging and/or leveraging a surface of a beverage or bottle cap between the beverage opener 106 and a distal end of the pet identification tag beverage opener 100. A distal surface 110 of the beverage opener 106 relative to the attachment means 102 rests on top of the bottle cap and acts as a fulcrum, while a lever arm 108 of the beverage opener 106 relative to the attachment means 102 is used to pry off the bottle cap.

The lever arm 108 makes up a portion of the body of the pet identification tag beverage opener 100. The lever arm 108 has specific dimensions (thickness, width, length) providing sufficient leverage for removing a beverage or bottle cap in operation while the pet identification tag beverage opener 100 is attached to the pet. The lever arm 108 is made with specific dimensions (height, thickness, length) and material(s) imparting sufficient strength and toughness to open beverages over several cycles throughout the life of the pet identification tag beverage opener 100.

In operation, the pet identification tag beverage opener 100 can be used to open a sealed beverage by wedging or fixing a surface the beverage opener pocket 106 upon a surface of beverage container or cap and imparting a sufficient angular force upon the lever arm 108 to pry or leverage off the beverage cap. Additionally, the identification region 104 provides identification information to identify the pet, the owner of the pet and the owner of the pet identification tag beverage opener 100 in case the pet or pet identification tag beverage opener 100 is lost.

FIG. 4 illustrates a top offset view of an exemplary pet identification tag beverage opener 200 according to another embodiment. The exemplary pet identification tag beverage opener 200 includes an attachment means 202, an identification region 204, a beverage opener 206, and a lever arm 208.

The pet identification tag beverage opener 200 including the beverage opener 206 and lever arm 208 is made with specific dimensions (height, thickness, length) and material(s) imparting sufficient strength and toughness to open beverages over several cycles throughout the life of the pet identification tag beverage opener 200. The pet identification tag beverage opener 200 including the beverage opener 206 and lever arm 208 can be made from any materials or combination of materials including, but not limited to one or more of the following materials: metals, alloys, ceramics, plastics, and composites.

The attachment means 202 can be any element upon or within the body or lever arm 208 for attaching the pet identification tag beverage opener 200 to a pet. In an exemplary embodiment, the attachment means 202 is a hole provided within the body or lever arm 208 of the pet identification tag beverage opener 200. A ring, rope, wire, string, split key ring, strap, zip tie, wire, rubber band or other element (not shown) can be used in conjunction with the attachment means hole 202 to attach the pet identification tag beverage opener 200 to a collar, ring, rope, wire or other element (not shown) around a pet's neck.

Although the location of the attachment means 202 is not critical, the attachment means 202 can be located at or near a geographic center (i.e. with respect to one or more axes) or at or near the center of gravity of the pet identification tag beverage opener 200. The attachment means 202 is centrally located in FIG. 4 to provide the most convenient configuration for pivoting the pet identification tag beverage opener 200 around a central point during operation.

The identification region 204 has a surface area large enough to contain and display identification information. Identification information can be permanently or temporarily affixed within the identification region 204. Identification information can be permanently applied in any number of ways including, but not limited to engraving, laser engraving, etching, writing, electrical discharge machining or any other method known in the art for affixing information to a specific material. The identification information can include pet information or pet owner information including, but not limited to, pet name, pet age, pet temperament, pet vaccination information, pet veterinarian address, pet owner name, pet owner address, pet owner telephone number or other desired information related to the pet or pet owner.

The beverage opener 206 is a pocket or recess portion of the body of the pet identification tag beverage opener 200. The beverage opener recess portion or pocket 206 includes a surface shaped for wedging and/or leveraging a surface of a beverage or bottle cap between the beverage opener 206 and a distal end of the pet identification tag beverage opener 200. A distal surface 210 of the beverage opener 206 relative to the attachment means 202 rests on top of the bottle cap and acts as a fulcrum, while a lever arm 208 of the beverage opener 206 relative to the attachment means 202 is used to pry off the bottle cap.

The lever arm 208 makes up a portion of the body of the pet identification tag beverage opener 200. The lever arm 208 has specific dimensions (thickness, width, length) providing sufficient leverage for removing a beverage or bottle cap in operation while the pet identification tag beverage opener 200 is attached to the pet. The lever arm 208 is made with specific dimensions (height, thickness, length) and material(s) imparting sufficient strength and toughness to open beverages over several cycles throughout the life of the pet identification tag beverage opener 200.

In operation, the pet identification tag beverage opener 200 can be used to open a sealed beverage by wedging or fixing a surface the beverage opener pocket 206 upon a surface of beverage container or cap and imparting a sufficient angular force upon the lever arm 208 to pry or leverage off the beverage cap. Additionally, the identification region 204 provides identification information to identify the pet, the owner of the pet and the owner of the pet identification tag beverage opener 200 in case the pet or pet identification tag beverage opener 200 is lost.

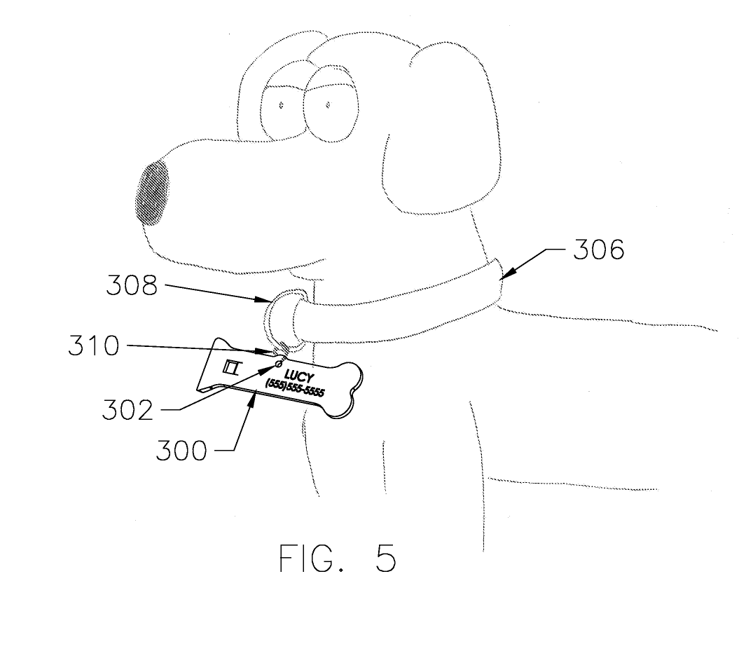

FIG. 5 illustrates an exemplary identification tag beverage opener 300 attached to a pet collar 306 according to one embodiment. The collar 306 has an attachment point 308 that is used to attach the pet identification tag beverage opener 300 via the attachment means 302 of the pet identification tag beverage opener 300. In this embodiment, a simple split key ring 310 is used in conjunction with the attachment means 302 but any secure object can be used including, but not limited to a ring, rope, wire, string, strap, split key ring, zip tie, wire, rubber band or other element for attaching the pet identification tag beverage opener 300 to a pet collar 306. Although a conventional pet collar 306 is illustrated in FIG. 5, the pet identification tag beverage opener 300 can be attached to any element including, but not limited to, rope, rubber band or other collar-like system on the pet.

The exemplary pet identification tag beverage openers herein disclosed provide the adding the utility of opening sealed beverage containers anytime and anywhere when an operator is accompanied by their beloved pet. It also equips a pet owner with the freedom to choose any collar or method to attach the exemplary pet identification tag beverage openers to the pet. Additionally, the exemplary pet identification tag beverage openers herein disclosed provide identification information to identify the pet, the owner of the pet and the owner of the pet identification tag beverage opener in case the pet or pet identification tag beverage opener is lost.

Example embodiments have been described hereinabove regarding improved systems and methods for providing utility to pet identifiers. Various modifications to and departures from the disclosed example embodiments will occur to those having ordinary skill in the art. The subject matter that is intended to be within the spirit of this disclosure is set forth in the following claims.

What is claimed is:

1. A pet identification apparatus comprising:
an attachment means;
an identification region;
a beverage opener; and
a lever arm.

2. The pet identification apparatus as recited in claim 1, wherein the attachment means comprises a hole for securing a ring for attaching to a pet collar.

3. The pet identification apparatus as recited in claim 1, wherein the attachment means is located at the geographic center of the pet identification apparatus.

4. The pet identification apparatus as recited in claim 1, wherein the attachment means is located at the center of gravity of the pet identification apparatus.

5. The pet identification apparatus as recited in claim 1, wherein the identification region comprises pet identification information or owner identification information.

6. The pet identification apparatus as recited in claim 1, wherein the pet identification information comprises one of pet name, pet age, pet temperament, pet vaccination information and pet veterinarian address.

7. The pet identification apparatus as recited in claim 1, wherein the pet owner identification information comprises one of pet owner name, pet owner address and pet owner telephone number.

8. The pet identification apparatus as recited in claim 1, wherein the beverage opener comprises a claw for prying a beverage cap off of a container.

9. The pet identification apparatus as recited in claim 1, wherein the beverage opener comprises a pocket comprising an engaging surface for prying a beverage cap off of a container.
